(19) United States
(12) Patent Application Publication
(10) Pub. No.: US 2007/0133939 A1
(43) Pub. Date: Jun. 14, 2007

(54) Hard disk equipped optical disk recorder

(75) Inventor: Hiroki Sawada, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/603,198

(22) Filed: Nov. 22, 2006

(30) Foreign Application Priority Data
Nov. 25, 2005 (JP) 2005-340083

(51) Int. Cl. H04N 5/91

(52) U.S. Cl. 386/46; 369/47.1

(57) ABSTRACT

A hard disk equipped optical disk recorder includes an optical disk drive which performs recording and reading of data to and from an optical disk loaded thereinto, and a hard disk drive which performs recording and reading of data to and from a hard disk. When the optical disk drive is recording data upon the optical disk, if the remaining capacity upon the optical disk becomes exhausted, the hard disk drive records the continuation data upon the hard disk. And, when the hard disk drive has completed recording the continuation data, the optical disk drive reads out the data recorded upon the optical disk, and moreover the hard disk drive records the data which the optical disk drive reads out upon the hard disk in correspondence with the continuation data.

### CROSS REFERENCE

This Nonprovisional application claims priority under 35 U.S.C. §119(a) on Patent Application No. 2005-340083 filed in Japan on Nov. 25, 2005, the entire contents of which are hereby incorporated by reference.

### BACKGROUND OF THE INVENTION

The present invention relates to a hard disk equipped DVD recorder which performs recording and reading of data to and from both optical disks, and a hard disk.

From the prior art, various types of hard disk equipped optical disk recorder have been considered. Such a hard disk equipped optical disk recorder comprises both an optical disk drive by which data is recorded upon an optical disk, and also a hard disk drive (hereinafter termed an “HDD”) by which data is recorded upon a hard disk (hereinafter termed an “HD”). The optical disks may be, for example, CDs or DVDs.

With a prior art type hard disk equipped optical disk recorder, if, during the recording of a TV program upon a DVD, the remaining capacity upon the DVD becomes exhausted, then the data continuing on therefrom continues to be recorded upon the HD, on a backup basis.

Due to this, with a prior art type hard disk equipped optical disk recorder, if, during the recording of a TV program upon a DVD, the remaining capacity upon the DVD becomes exhausted, then, by performing the backup basis recording described above, the recording of the TV program is not broken off partway through, and it is possible to record the entire TV program up to its end.

On the other hand, a hard disk equipped optical disk recorder as described in Japanese Laid-Open Patent Publication 2004-334867 has been proposed.

However, with such a prior art type hard disk equipped optical disk recorder, in the case of a TV program which has been recorded on the above described backup basis, its front half portion and its rear half portion have become separated, with the front half portion having been recorded upon the DVD and the rear half portion having been recorded upon the HD.

Due to this, when performing replay of a TV program after having recorded it by the above described backup basis recording, it is necessary first to view the front half portion of the TV program from the DVD, and to then view the subsequent portion from the HD.

Furthermore, when the user attempts to view the rear half portion of the TV program without interruption directly after having viewed the front half portion, the HD of the hard disk equipped optical disk recorded is accessed. At this time, a certain time period is required for the magnetic head of the HDD to seek to the region of the HD upon which this rear half portion is recorded, so that the user is required to wait for this certain time period.

Thus, as described above, with such a prior art type hard disk equipped optical disk recorder, when performing replay after having made such a backup basis recording as described above, a certain amount of labor has been required for changing over the replay medium, and moreover it has not been possible to perform seamless replay. Accordingly, with such a prior art type hard disk equipped optical disk recorder, in a scenario in which replay is to be performed after having made such a backup basis recording as described above, the convenience from the point of view of the user is poor.

Moreover, with the hard disk equipped optical disk recorder described in the above Japanese Laid-Open Patent Publication 2004-334867, it is possible to record the front half portion of a TV program upon a first DVD, and thereafter to record the rear half portion thereof upon a second DVD separately. Accordingly, the same problem occurs as with the above described hard disk equipped optical disk recorder. Furthermore, with this hard disk equipped optical disk recorder, it is also possible for the user to perform manual editing, so as to splice together a TV program which has been recorded as extending over two separate DVDs onto a single DVD. However, a serious effort from the user is called for, in order for this manual editing to be performed.

The object of the present invention is to provide a hard disk equipped optical disk recorder, which curtails the labor required for changing over the replay medium while performing replay after the above described backup basis recording has been performed and which can thus provide a seamless replay performance, and which moreover enhances the convenience from the point of view of the user.

### SUMMARY OF THE INVENTION

The hard disk equipped optical disk recorded according to the present invention includes an optical disk drive which performs recording and reading of data to and from an optical disk loaded thereinto, and a hard disk drive which performs recording and reading of data to and from a hard disk. In this structure the optical disk may be, for example, a CD or a DVD.

When the optical disk drive is recording data upon the optical disk, if the remaining capacity upon the optical disk becomes exhausted, the hard disk drive records the continuation data upon the hard disk. With this structure the data may be, for example, data related to a TV program.

And, when the hard disk drive has completed recording the continuation data, the optical disk drive reads out the data recorded upon the optical disk.

Moreover, the hard disk drive records the data which the optical disk drive reads out upon the hard disk in correspondence with the continuation data.

With this structure, if, while the optical disk drive is recording data upon the optical disk, the remaining capacity of the optical disk becomes exhausted, then the above described hard disk drive (hereinafter abbreviated as “HDD”) performs backup basis recording to record the data continuing on therefrom (for example, the rear half of a TV program) on the HD without any interruption. As a result, the front half portion of the TV program comes to be recorded upon the optical disk, while the rear half portion of the TV program comes to be recorded separately upon the HD.

Then, after the recording of the TV program or the like has been completed onto the HDD, the data which is read out by the optical disk drive from the optical disk (for example, the front half portion of the TV program) is recorded upon the hard disk in correspondence with the continuation data (for example, the rear half portion of the TV program). This correspondence means that the front half portion of the TV program and its rear half portion are logically connected together in, for example, the management information of the hard disk (for example, in its file system). By doing this, the TV program or the like comes to be recorded all together as one unit upon the hard disk, which is a single medium.

### BRIEF DESCRIPTION OF THE DRAWINGS

FIG. 1 is a block diagram showing the structure of a hard disk equipped DVD recorder which is an embodiment of the present invention;

FIG. 2 is a flow chart showing operations performed by an MPU of this hard disk equipped DVD recorder which is an embodiment of the present invention;

FIGS. 3A through 3D are figures showing time charts during video recording of a TV program;

FIG. 4 is a flow chart showing operations performed by an MPU of a hard disk equipped DVD recorder which is another embodiment of the present invention; and

FIGS. 5A and 5B are conceptual diagrams for this hard disk equipped DVD recorder which is another embodiment of the present invention, showing data arrangement states upon the hard disk when the TV program has been consolidated together upon the hard disk.

### DETAILED DESCRIPTION OF THE INVENTION

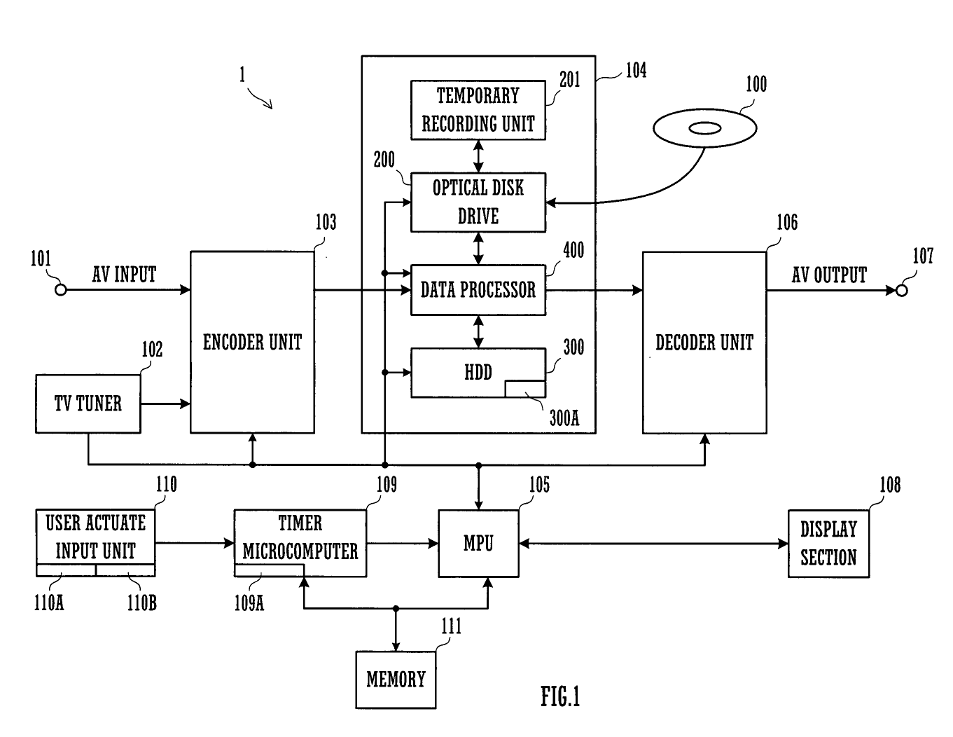

FIG. 1 is a block diagram showing the structure of a hard disk equipped DVD recorder which is an embodiment of the present invention. This hard disk equipped DVD recorder 1 comprises: a recording and replay unit 104 which records upon a predetermined medium data which has been inputted, according to a record command, and also replays data which has already been recorded, according to a replay command; and a micro computer (an MPU; in other words, a main control device) 105 which executes recording operation to the recording and replay unit 104 and replay operation from the recording and replay unit 104, and also controls various sections of the recorder 1, as will be explained hereinafter.

The recording and replay unit 104 may comprise: an optical disk drive 200 which is capable of recording and replaying data (such as data for a TV program or the like) to and from an optical disk 100 loaded thereinto which has, for example, been manufactured in conformity to the DVD (Digital Versatile Disk) standard; a temporary recording unit 201 which is capable of temporarily storing a fixed amount of data which is being recorded upon the optical disk 100 or which has been read out from the optical disk 100; an HDD (hard disk drive) 300 which is capable of recording a large amount of data upon an internal HD 300A; and a data processor 400. The temporary recording unit 201 functions as a buffering memory.

The optical disk 100 is supposed to be an optical disk upon which recording can be performed, such as a recordable DVD-R or a rewriteable DVD-RAM or the like.

It should be understood that although, in this embodiment, the optical disk 100 is assumed to be a DVD, when implemented, it could also be a CD.

According to control by the MPU 105, the optical disk drive 200 performs rewriting of management data recorded upon the optical disk 100, and deletion of data recorded upon the optical disk 100.

According to control by the MPU 105, the HDD 300 performs rewriting of management data recorded upon the HD 300A, and deletion of data recorded thereupon. Furthermore, the HDD 300 is endowed with a “defrag” function of performing defragmentation upon the HD 300A.

According to control by the MPU 105, the data processor 400 supplies data for recording, which has been outputted from an encoder unit 103, either to the optical disk drive 200 or the HDD 300.

Furthermore, the data processor 400 takes in the replay signal of the optical disk 100 from the optical disk drive 200, and supplies it to a decoder unit 106. Moreover, the data processor 400 supplies the replay signal from the HDD 300 to the decoder unit 106.

Moreover, according to control by the MPU 105, the data processor 400 supplies data read out from the optical disk drive 200 to the HDD 300, and supplies data read out from the HDD 300 to the optical disk drive 200.

It should be understood that the data processor 400 and the MPU 105 correspond to the “supply control means” of the Claims.

An AV input terminal 101 inputs a video signal and an audio signal which are to be the subject for recording from the exterior of the hard disk equipped DVD recorder 1, and outputs them to the encoder unit 103 which is connected thereto. The internet may be, for example, connected to the exterior of the recorder 1.

A tuner 102 is connected to an antenna (not shown in the figures) which receives a television broadcast signal distributed from, for example, a broadcasting entity. And this tuner 102 extracts a television broadcast signal upon a selected channel from among the television broadcast signals received by the antenna, and outputs this signal to the encoder unit 103.

It should be understood that the AV input terminal 101 and/or the tuner 102 corresponds to the “input source” of the Claims.

The encoder unit 103 encodes and compresses (for example by MPEG2) the video signal and the audio signal which have been inputted from the AV input terminal 101, and outputs them to the data processor 400 as data to be recorded.

Furthermore, the encoder unit 103 separates the video signal and the audio signal from the television broadcast signal which is inputted from the tuner 102. And the encoder unit 103 encodes and compresses this video signal and audio signal, and outputs them to the data processor 400 as data to be recorded.

The decoder unit 106 decodes and expands the signal to be replayed which has been outputted from the recording and replay unit 104. And an AV output terminal 107 is connected to the decoder unit 106, in order to supply this signal to be replayed which has been decoded (by the decoder unit 106) to a replay device such as a television or the like.

A timer microcomputer 109 is connected to the MPU 105.

This timer microcomputer 109 comprises a timer circuit (a clock unit) 109A which is utilized for time period management of the hard disk equipped DVD recorder 1. A user actuation input unit 110 is connected to the timer microcomputer 109 for receiving actuation (commands) from the user.

Furthermore, a display section 108 which displays the operational state of the hard disk equipped DVD recorder 1, and a memory 111 such as an EEPROM or the like, are connected to the MPU 105.

The memory 111 stores control programs.

Based upon the control programs stored in the memory 111, the MPU 105 controls the recording operations for data upon the HD and upon the optical disk 100 and the corresponding reading out operations, replay operations and deletion operations, and also controls display operation upon the display section 108 and so on.

The MPU 105 acquires management information for the optical disk 100 or the HD 300A from the temporary recording unit 201, the optical disk drive 200, or the HDD 300. And, from this management information which it has acquired, the MPU 105 monitors the remaining capacity of the HD 300A which is housed in the HDD 300 and of the optical disk 100 which is loaded into the optical disk drive 200.

The user actuation input unit 110 comprises a video recording key, a replay key and a stop key for video recording of TV programs, and various other control keys. And, by actuating these keys, the user performs input and the like for video recording and replay, and for video recording scheduling. Furthermore, the user actuation input unit 110 comprises a data reception unit 110B which receives and inputs control signals transmitted from a remote control (a remote control terminal) not shown in the figures, and a control panel 110A which can receive direct input from the user, and can output control signals to the timer microcomputer 109 or the MPU 105.

It should be understood that, when the current time reaches a scheduled video recording time point, the timer microcomputer 109 commands the MPU 105 to start video recording.

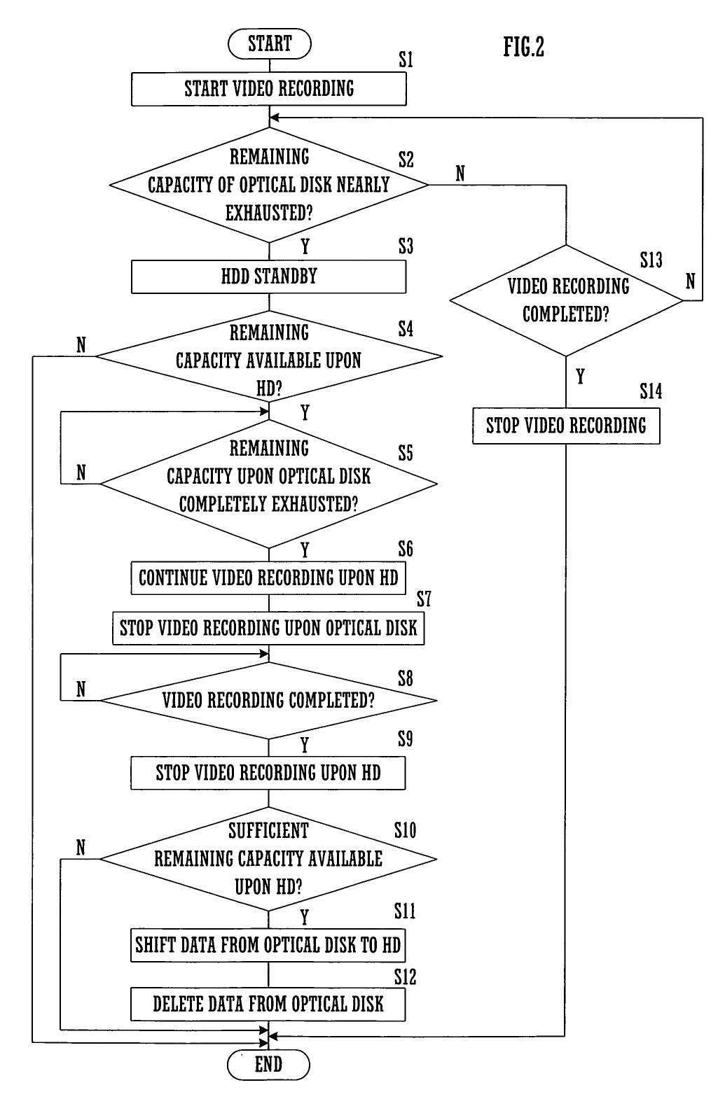

FIG. 2 is a flow chart showing operations performed by the MPU 105 of this hard disk equipped DVD recorder which is an embodiment of the present invention. This operation is started upon being triggered by a video recording start command due to the video recording key being pressed, or from the timer microcomputer 109.

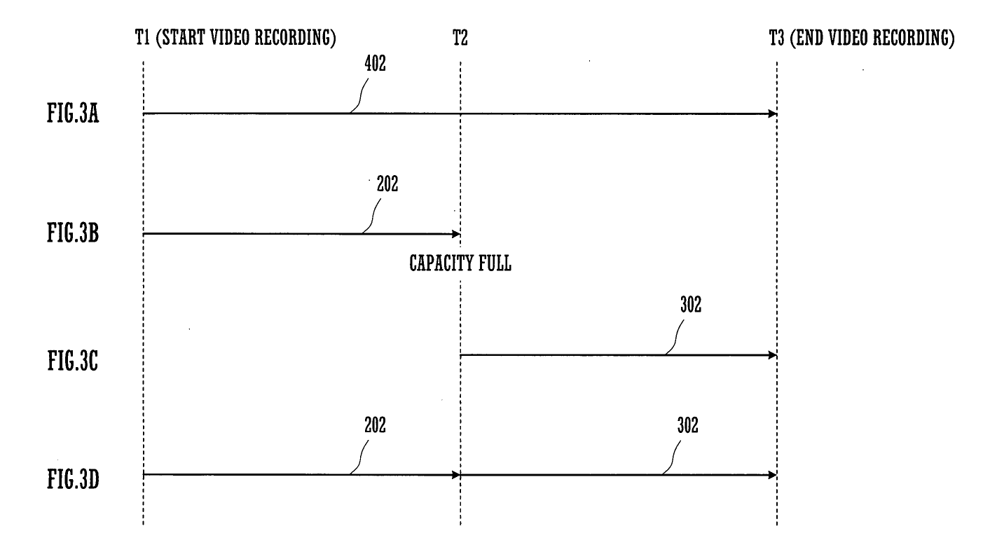

FIGS. 3A through 3D are figures showing time charts for video recording of a TV program.

FIG. 3A shows the entire time period (t₃-t₁) which is required for video recording some TV program 402. FIG. 3B shows a situation in which, during the video recording of this TV program 402 upon the optical disk 100, at the time point t₂, the remaining capacity of the optical disk 100 has become exhausted, so that it has become impossible to continue video recording past the front half portion 202 of the TV program 402. And FIG. 3C shows a situation in which, at the time point t₂, the remaining capacity of the optical disk 100 has become exhausted, and thereafter the rear half portion 302 of the TV program 402 has been video recorded from the time point t₂. Moreover, FIG. 3D shows a situation in which, when the recording of the rear half portion 302 of the TV program 402 has been completed, the front half portion 202 of the TV program 402 which has been recorded upon the optical disk 100 has been recorded upon the HD 300A, with a correspondence being established with the rear half portion of the TV program 402.

It should be understood that t₁, t₂, and t₃ all denote time points, and time elapses from each of these to the next in that order.

Moreover while, in FIGS. 2 and 3, the operation while video recording a TV program 402 will be explained, this is to be considered as being representative, not only of video recording a TV program 402, but also of video recording image data distributed from the internet or the like.

First, when a video recording start command is issued due to the video recording key being pressed, or from the timer microcomputer 109, in order to perform video recording of the TV program 402, the MPU 105 starts controlling the various sections of this hard disk equipped DVD recorder 1 (a step S1). For example, the MPU 105 may command the data processor 400 to supply the data to be recorded, which is outputted from the encoder unit 103, to the optical disk drive 200.

Next, the MPU 105 decides whether or not the remaining capacity of the optical disk 100 is nearly exhausted (a step S2). The MPU 105 performs this decision by monitoring the remaining capacity of the optical disk 100, and deciding whether or not its remaining capacity is below a predetermined threshold value. This predetermined threshold value may be, for example, 500 KB, 100 KB, 10 KB, or 1 KB.

If the result of this decision is that the remaining capacity of the optical disk 100 is not nearly exhausted, then the MPU 105 decides whether or not the video recording of the TV program 402 has been completed (a step S13). If it is decided that the video recording has not been completed, then the MPU 105 returns to the step S2 and continues the processing.

In other words, in the steps S2 and S13, while the optical disk drive 200 is recording (video recording) data upon the optical disk 100, the MPU 105 keeps deciding whether or not the remaining capacity in the optical disk 100 is almost exhausted.

On the other hand, if in the step S13 it is decided that the video recording has been completed, then the MPU 105 stops video recording of the TV program 402 (a step S14), and terminates this processing. In the step S14, the scenario is assumed that the HD 300A has not yet been employed, and that it has been possible for the optical disk drive 200 to record the entire TV program 402 upon the optical disk 100.

On the other hand, if the result of the decision in the step S2 is that the remaining capacity of the optical disk 100 is nearly exhausted, then the MPU 105 puts the HDD 300 upon standby (a step S3). In concrete terms, for example, the MPU 105 may search the HDD 300 for a vacant region for recording, so as to be able immediately to record in this vacant region upon the HD 300A, when the remaining capacity of the optical disk 100 does become exhausted.

The MPU 105 then decides whether or not the HD 300A has sufficient remaining capacity to be able to ensure storage of the continuation data of the TV program 402 (i.e. of the rear half portion 302 of the TV program 402) (a step S4). The MPU 105 performs this decision by monitoring the remaining capacity of the HD 300A.

If the result of the decision in the step S4 is that the HD 300A does not have sufficient remaining capacity to be able to ensure storage of the rear half portion 302 of the TV program 402, then the MPU 105 terminates this processing. In this case, only the front half portion 202 of the TV program 402 is recorded upon the optical disk 100 (refer to FIG. 3B).

On the other hand, if the result of the decision in the step S4 is that the HD 300A does have sufficient remaining capacity to be able to ensure storage of the continuation data of the TV program 402, then the MPU 105 decides whether or not the remaining capacity upon the optical disk 100 has become completely exhausted (a step S5). The MPU 105 performs this decision by monitoring the remaining capacity of the optical disk 100.

After waiting until the remaining capacity of the optical disk 100 has become completely exhausted (in the step S5), the MPU 105 commands the HD 300 to continue with the recording of this continuation data (i.e. the rear half portion 302 of the TV program 402) in a vacant region upon the HD 300A (a step S6). In more detail, the MPU 105 commands the data processor 400 to supply the data to be recorded, which is being outputted from the encoder unit 103, to the HDD 300. Moreover, the MPU 105 commands the optical disk drive 200 to stop recording (a step S7).

The situation in which the remaining capacity of the optical disk 100 has become exhausted is the situation at the time point t₂ in FIG. 3B. And the situation in which the HDD 300 is continuing to record the continuation data (the rear half portion 302 of the TV program 402) in the vacant region of the HD 300A, is the situation at the time point t₂ in FIG. 3C.

The MPU 105 then decides whether or not the video recording of the TV program 402 has been completed (a step S8). This decision is the same as that performed in the step S13.

After having waited for the video recording of the TV program 402 to be completed (in the step S8), the MPU 105 terminates the recording operation upon the HDD 300 (a step S9). Due to this, the HDD 300 stops the video recording of data upon the HD 300A (refer to the time point t₃ in FIG. 3C). At the time point of the step S9, as shown in FIG. 3C, the rear half portion 302 of the TV program 402 is recorded upon the HD 300A.

When the video recording is ended, the MPU 105 decides whether or not the HD 300A has sufficient capacity to be able to record the data which has been recorded upon the optical disk 100 (i.e. the front half portion 202 of the TV program 402) (a step S10). The MPU 105 performs this decision by monitoring the remaining capacity of the HD 300A.

If the result of this decision is that the HD 300A does not have sufficient capacity to be able to record the data which has been recorded upon the optical disk 100 (i.e. the front half portion 202 of the TV program 402), then the MPU 105 terminates this processing. In this case, the video recording process is ended in a state in which the front half portion 202 and the rear half portion 302 of the TV program 402 are separated, with the front half portion 202 having been recorded upon the optical disk 100 (refer to FIG. 3B), while the rear half portion 302 is recorded upon the HD 300A (refer to FIG. 3C). This state is the same as was the case with a prior art hard disk equipped DVD recorder.

On the other hand, if the result of the decision in the step S10 is that the HD 300A does have sufficient capacity to be able to record the data which has been recorded upon the optical disk 100 (i.e. the front half portion 202 of the TV program 402), then the MPU 105 records the data which is currently recorded upon the optical disk 100, upon the HD 300A (a step S11). In other words, the MPU 105 commands the optical disk drive 200 to read out the data which is recorded upon the optical disk 100 (i.e. the front half portion 202 of the TV program 402). And the MPU 105 commands the HDD 300 to record this data which has been read out (i.e. the front half portion 202 of the TV program 402) upon the HD 300A, while establishing a correspondence with the continuation data (i.e. the rear half portion 302 of the TV program 402), which has already been recorded upon the HD 300A. Establishing this correspondence does not mean that the data is actually recorded consecutively; rather, it means that, in the management information for the HD 300A (for example, its file system), the front half portion 202 of the TV program 402 and the rear half portion 302 of the TV program 402 are connected together logically. By doing this, as shown in FIG. 3D, the TV program 402 comes to be recorded as a whole upon the HD 300A, which thus constitutes a single medium.

According to the above, in the scenario in which the user views the rear half program 302 of the TV program 402 immediately straight through after viewing its front half portion 202, it is possible to eliminate the task of changing over the replay medium. Furthermore, since the replay medium does not need to be changed over, accordingly it is possible to perform seamless replay. Moreover, since the TV program 402 is automatically recorded as a whole upon the single HD 300A, it is not necessary to perform any manual editing work for combining the TV program onto a single medium. Accordingly, the convenience of use from the point of view of the user is enhanced.

It should be understood that although, in this embodiment, video recording of a TV program 402 was performed, this should not be considered as being limitative of the present invention. In implementation, the data may be of any type, provided that it is of a kind which can be inputted from the AV input terminal 101. This data may be, for example, photographic moving images, or may be audio which has been sound recorded.

Next, the MPU 105 deletes the data which has been read out (i.e. the front half portion 202 of the TV program 402) from the optical disk 100 (a step S12), and terminates this processing. In the step S12, the case is assumed in which the optical disk 100 is an optical disk of a rewritable type.

By doing this, it is possible for an empty region to be automatically created upon the optical disk 100. Due to this, the user does not make this region useless, but rather it can be taken advantage of effectively. Furthermore, it is also possible to prevent the user from mistakenly replaying the optical disk 100, irrespective of whether or not, in the step S11, all of the TV program 402 has been recorded upon the HD 300A as a whole.

It should be understood that, if the optical disk 100 is a write once cumulatively type optical disk, the MPU 105 should skip this step S12. It is possible simply and easily to distinguish whether the optical disk is a rewritable type or a write-once read-many type optical disk by, for example, measuring the reflectivity of the disk or checking its RMA (Recording Management Area).

In the following, another embodiment of the present invention will be explained.

The hard disk equipped DVD recorder of this embodiment has the same hardware structure as the hard disk equipped DVD recorder of the first embodiment described above.

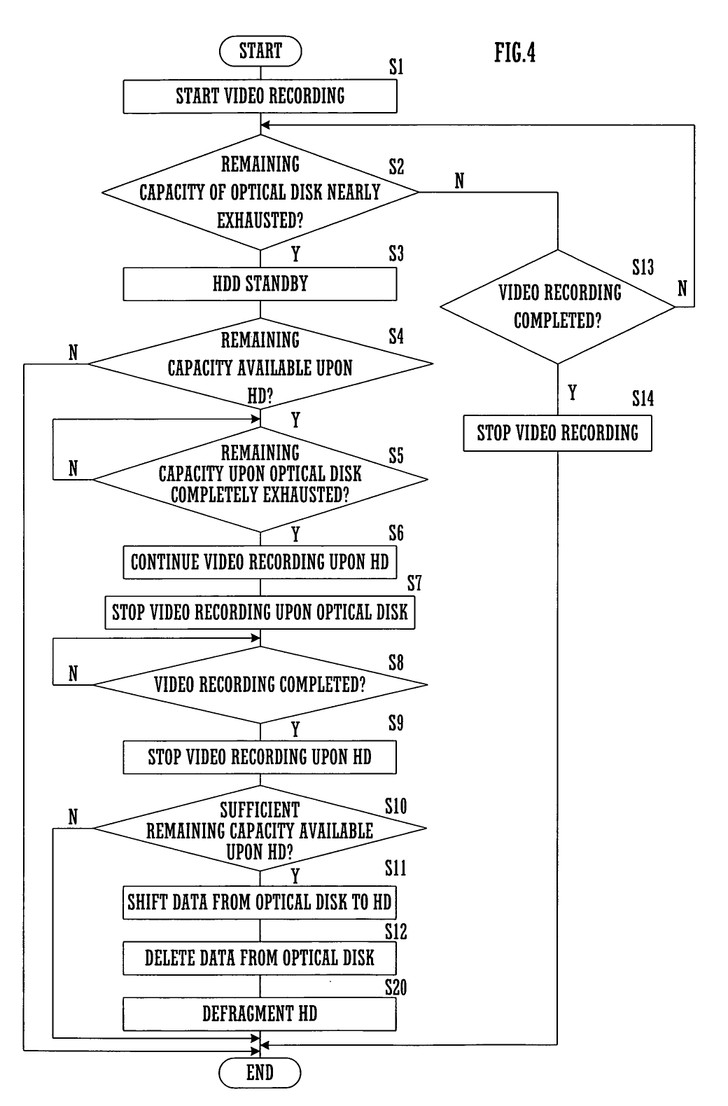

FIG. 4 is a flow chart showing operations performed by the MPU 105 of this hard disk equipped DVD recorder according to this other embodiment of the present invention. In this operation, the processing shown in a step S20 is appended after the step S12 of the FIG. 2 flow chart; the other processing steps (S1 through S14) are the same as before.

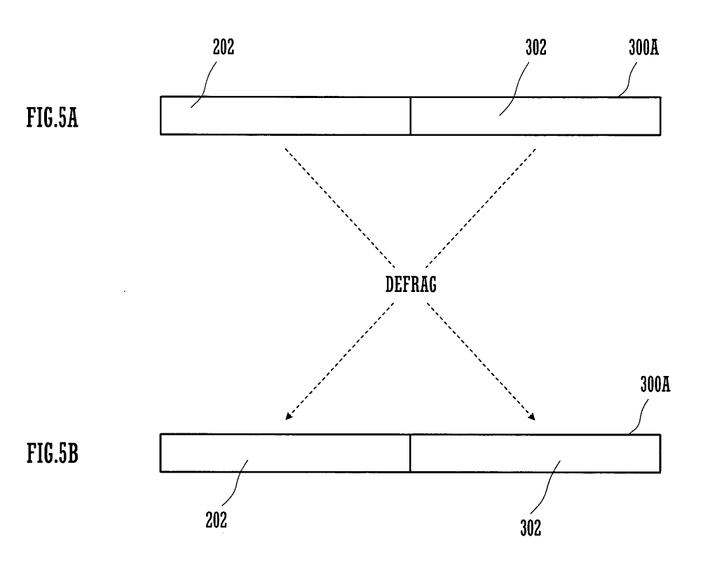

And FIG. 5 is a conceptual figure for this hard disk equipped DVD recorder according to this other embodiment of the present invention, showing the data arrangement situation upon the HD 300A, when the TV program 402 has all been consolidated upon the single medium.

FIG. 5A is a conceptual figure showing the data arrangement situation upon the HD 300A, immediately after the data which was recorded upon the optical disk 100 has been shifted to the HD 300A in the step S11 of the FIG. 2 flow chart. FIG. 5A corresponds to FIG. 3D. Furthermore, FIG. 5B is a conceptual figure showing the data arrangement situation upon the HD 300A, after defragmentation has been performed.

When, in the step S11, the data which was recorded upon the optical disk 100 (i.e. the front half portion 202 of the TV program 402) is shifted to the HD 300A, as shown in FIG. 5A, the arrangement of the data upon the HD 300A is that the rear half portion 302 of the TV program 402 is positioned first, and the front half portion 202 of the TV program 402 is positioned thereafter. The reason for this type of arrangement is that the rear half portion 302 of the TV program 402 has been recorded upon the HD 300A first in the step S6 and the front half portion 202 of the TV program 402 has been recorded upon the HD 300A subsequently, in the step S11.

Due to this, at the stage of the step S11 in which the data which is recorded upon the optical disk 100 is shifted to the HD 300A, so called fragmentation of the HD 300A takes place. Because of this, when the user attempts to view the rear half program 302 of the TV program 402 immediately straight through after viewing its front half portion 202, it is necessary for the magnetic head (not shown in the figures) of the HDD 300 to seek over the HD 300A to its region upon which the rear half portion 302 is recorded, which is a considerable distance away from its region upon which the front half portion 202 is recorded.

Accordingly, there is a possibility that the user may be caused to wait for a short time until the magnetic head of the HDD 300 reaches the target region, which is undesirable.

Thus, in this embodiment, the MPU 105 performs defragmentation of the HDD 300 in a step S20. As a result, the data arrangement situation upon the HD 300A is amended to the state in which the rear half portion 302 of the TV program 402 is positioned directly after its front half portion 202, as shown in FIG. 5B. To put this in another manner, the front half portion 202 of the TV program 402 and its rear half portion 302 are spliced together, and thereby the TV program 402 is stored upon the HD 300A as a single continuous stream of data.

Due to this, fragmentation of the HD 300A is eliminated. As a result, when the user views the rear half program 302 of the TV program 402 immediately straight through after viewing its front half portion 202, at the point of transition between these two TV program halves, it is not necessary for the magnetic head of the HDD 300 to seek any relatively long distance to the region upon the HD 300A in which the rear half portion 302 is recorded.

Since, according to the above, it is not necessary for the magnetic head to seek over the HD 300A, accordingly it is possible to perform replay with yet a further level of seamlessness. Therefore, the convenience of use from the point of view of the user is enhanced by yet a further level.

What is claimed is:

1. A hard disk equipped optical disk recorder, comprising:
an optical disk drive which performs recording and reading of data to and from an optical disk loaded thereinto; and
a hard disk drive which performs recording and reading of data to and from a hard disk, wherein:
when the optical disk drive is recording data upon the optical disk, if the remaining capacity upon the optical disk becomes exhausted, the hard disk drive records the continuation data upon the hard disk;
when the hard disk drive has completed recording the continuation data, the optical disk drive reads out the data recorded upon the optical disk; and
the hard disk drive records the data which the optical disk drive reads out upon the hard disk, in correspondence with the continuation data.

2. A hard disk equipped optical disk recorder as described in claim 1, further comprising a supply control means which supplies data inputted from an input source to either one of the optical disk drive and the hard disk drive, and which also monitors the remaining capacity of the optical disk which is loaded into the optical disk drive, wherein the supply control means:
upon a command for recording data, supplies data which inputted from the input source to the optical disk drive; and
supplies the data continuing on therefrom to the hard disk drive if, during the recording of the data by the optical disk drive upon the optical disk, the remaining capacity of the optical disk becomes exhausted.

3. A hard disk equipped optical disk recorder as described in claim 1, wherein the supply control means:
when the hard disk drive has completed recording the continuation data, commands the optical disk drive to read out the data which has been recorded upon the optical disk; and
commands the hard disk drive to record the data which has been read out by the optical disk drive upon the hard disk, in correspondence with the continuation data.

4. A hard disk equipped optical disk recorder as described in claim 1, wherein:
the optical disk is a rewritable type optical disk; and
the optical disk drive, after having read out data recorded upon the optical disk, deletes the data which has been read out from the optical disk.

5. A hard disk equipped optical disk recorder as described in claim 1, wherein, after having recorded data read out by the optical disk drive upon the hard disk in correspondence with the continuation data, the hard disk drive executes defragmentation.
